(19) United States
(12) Patent Application Publication
(10) Pub. No.: US 2013/0031128 A1
(43) Pub. Date: Jan. 31, 2013

(54) DIGITAL SIGNAGE TRANSACTION SYSTEMS AND METHODS

(71) Applicants: Michael A. Provencher, Cypress, TX (US); Kent E. Biggs, Tomball, TX (US); Robert Joseph Rosenberry, Houston, TX (US)

(72) Inventors: Michael A. Provencher, Cypress, TX (US); Kent E. Biggs, Tomball, TX (US); Robert Joseph Rosenberry, Houston, TX (US)

(21) Appl. No.: 13/194,504

(22) Filed: Jul. 29, 2011

(51) Int. Cl. G06F 7/10; G06F 17/30

(52) U.S. Cl. 707/769; 707/E17.014

(57) ABSTRACT

Digital signage transaction systems and methods are therefore provided. An illustrative transaction method can include accessing, via a computing device, a plurality of digital sign files disposed within a repository. The transaction method can further include communicating at least one external selection criterion to the computing device. Responsive to the at least one external selection criterion, selecting at least a portion of the digital sign data files and communicating at least one of the portion of selected digital sign files from the repository to a display device.

### BACKGROUND OF THE INVENTION

### Description of the Related Art

With the reduction in costs associated with digital media, the sun is gradually setting on the days of paper wallboard advertising exclusivity. Advances in digital technology now enable digital sign designers and distributors to communicate directly with retailers. Such communication enables the generation of custom content tailored to the circumstances of an individual retailer—flexibility and responsiveness that would be neither economic nor practical using traditional poster-type signage. The increasing number of digital signs available to retailers, however, forces the retailer to parse through a plethora of digital sign options simply to select signage appropriate for his or her business.

### BRIEF DESCRIPTION OF THE DRAWINGS

Advantages of one or more disclosed embodiments may become apparent upon reading the following detailed description and upon reference to the drawings in which:

FIG. 1 is a schematic depicting an illustrative digital signage transaction system, according to one or more embodiments described herein;

FIG. 2 is a flow diagram depicting an illustrative digital signage transaction method, according to one or more embodiments described herein;

FIG. 3 is a flow diagram depicting another illustrative digital signage transaction method, according to one or more embodiments described herein; and

FIG. 4 is a schematic diagram depicting another illustrative digital signage transaction system, according to one or more embodiments described herein.

### DETAILED DESCRIPTION

Digital signage continues to grow in popularity due in part to its inherent flexibility, versatility, and effectiveness in appealing to consumers. Digital media content can, however, be difficult to acquire in the absence of a relationship with many manufacturers or distributors of content, or with a custom solution provider specializing in the creation of content for specific environments, for example a local small-to-medium sized business (“SMB”).

Development of a repository where digital sign media can be accumulated potentially solves the issue of availability of digital signage, yet would place retailers in the unenviable position of sorting through hundreds or even thousands of digital sign files simply to select those appropriate for their environment. For example, the owner of a local bicycle shop may have to sort through thousands of digital signs displaying unrelated items before finding the bicycle signs, only to have to sort through tens or even hundreds of bicycle signs unrelated to his or her stock. Once the retailer found relevant signage appropriate for his or her business, the retailer would then have to select and potentially purchase signage of uncertain pedigree and unknown commercial effectiveness.

A digital signage transaction system is therefore provided. An illustrative system can include a plurality of digital sign data files disposed within a repository accessible by a computing device. The system can further include at least one display device coupled to the repository. At least one external selection criterion can be coupled to the computing device, and logic can be executed by the computing device. Responsive to the at least one external selection criterion, the logic can: select at least one of the plurality of digital sign files from the repository; and communicate the at least one selected digital sign data file to the at least one display device.

As used herein, the term “couple” or “coupled” can refer to any form of direct, indirect, optical or wireless electrical connection. The electrical connection can, in one or more embodiments, include, but is not limited to any electrically conductive or magnetically inductive connection linking two or more devices. The connection can be electrically conductive, for example using one or more conductors such as copper or aluminum wire, conductive strips on a printed circuit board, or the like to connect two or more components.

As used herein, the terms “communicate,” “communication,” and any process referred to as “communicating” can refer to one-way data transmission or receipt or two-way data transmission and receipt. The term can variously refer to, for example, analog or digital data transmission, analog or digital data receipt, or analog or digital data transmission and receiving.

A digital signage transaction method is also provided. An illustrative method can include accessing, via a computing device, a plurality of digital sign files disposed within a repository. The method can further include communicating at least one external selection criterion to the computing device. Responsive to the at least one external selection criterion, selecting at least a portion of the digital sign data files and communicating at least one of the portion of selected digital sign files from the repository to a display device.

Another digital signage transaction method is also provided. Another illustrative method can include updating inventory data in an inventory database and communicating at least one external selection criterion including the inventory data to a computing device. Responsive to the external selection criterion, the method can include selecting at least a portion of a plurality of digital advertising media files disposed in a repository remote from the computing device; and communicating at least one of the portions of selected digital advertising media files from the repository to a display device.

The ability to quickly parse a large number of digital sign files stored within a repository, such as a digital signage cloud storage repository location, marketplace, exchange, or the like, can facilitate the efficient selection of relevant digital sign files for by a user. Further enhancing the selection process through the use of one or more external selection criterion can permit the expeditious selection of only those digital sign files displaying a heightened degree of relevancy compared to the external selection criterion. Such criterion can, for example, permit the selection of digital sign files relevant to a particular product, brand, season, or customer profile.

Example Digital Signage Transaction System

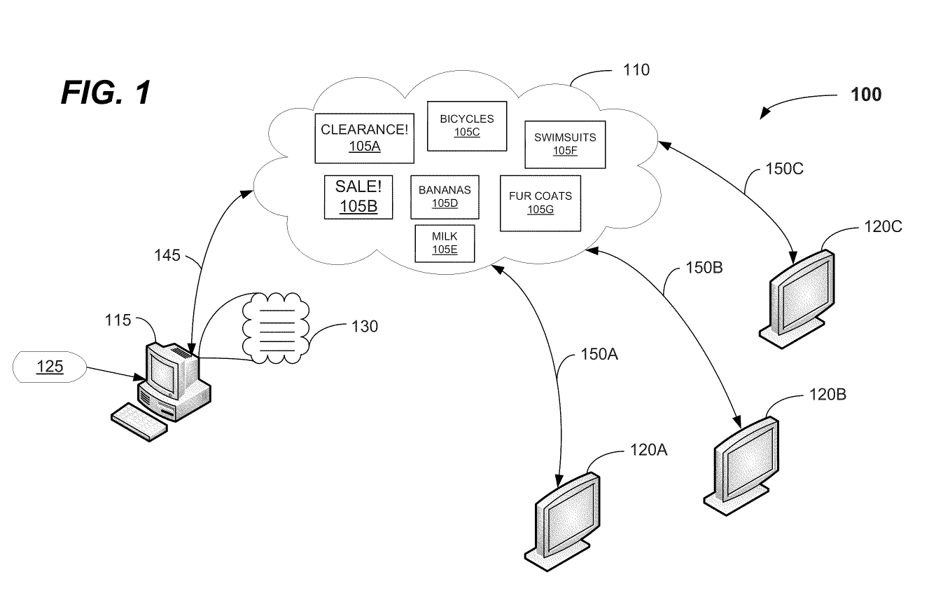

FIG. 1 is a schematic depicting an illustrative digital signage transaction system 100, according to one or more embodiments. The system 100 can include, but is not limited to a plurality of digital sign data files 105A-G disposed within a repository 110. A computing device 115 can be coupled 145 to the repository 110. At least one display device 120A-C can be coupled 150A-C to the repository 110. At least one external selection criterion 125 can be coupled to the computing device 115. Logic 130 executed at least in part by the computing device 115 can, in response to the communication of the at least one external selection criterion 125 to the computing device 115, select at least one of the plurality of digital sign files 105A-G from the repository 110 and communicate the at least one selected digital sign data file to the at least one display device 120A-C.

With the example system 100 depicted in FIG. 1, a user can access the digital sign files 105A-G within the repository 110. Based at least in part upon the at least one external selection criterion 125, one or more digital sign data files 105A-G can be selected for transmission from the repository 110 to some or all of the at least one display device 120A-C. The at least one external selection criterion 125 can be provided either by the user or provided as an electronic input to the computing device 115.

The plurality of digital sign files 105A-G can include any type of digital file suitable for providing either a static or dynamic media output (e.g., image, video, audio, or any combination thereof) on a display device. Example image file types can include, but are not limited to: JPEG, EXIF, TIFF, PNG, GIF, BMP, CGS, SVG, PNS, and JPS file formats. Example video file types can include, but are not limited to: MPEG, MOV, WMV, and RM file formats. Some or all of the plurality of digital sign files 105A-G may have associated keywords, tags, metadata, or the like. Such metadata can include product type or product brand name data describing the products to which the digital sign file applies. For example, metadata attached to a digital sign file containing Trek bicycle related content may indicate the “product” as a “bicycle” and the “brand” as “Trek.”

Additional metadata or tags can be added to each digital sign file 105 to further classify, detail, or categorize the content of the file. Dependent upon the content of the digital sign file 105, differing quantities or types of metadata may be present; for example some files may be categorized by approach (e.g., humorous, serious, etc.); while other files may be categorized by target audience (e.g., male, female, children, elderly, etc.); while yet other files may be categorized by genre (e.g., retro, modern, noir, etc.).

Using just one example as depicted in FIG. 1, each of the digital sign files 105A-G contains metadata indicating the “product type” to which the file applies: sign file 105A applies to generic merchandise on “clearance”; data file 105B applies to generic merchandise on “sale.” Similarly, data file 105C is related to “bicycles”; 105D is related to “bananas”; 105E is related to “milk”; 105F is related to “swimsuits”; and 105G is related to “fur coats.” A plurality of digital sign files 105A-G, each having identifying metadata can therefore be stored within the repository 110.

More than one version of each digital sign file 105A-G can be disposed within the repository 110. The various versions of each digital sign file 105 can be optimized for the display specific parameters of a particular type or class of display device. For example, a single advertisement may be stored in multiple digital sign files, with one digital sign file optimized for 1920×1200 high definition (HD) displays and another digital sign file optimized for 4:3 standard definition displays. A particular version of a digital sign file 105 can be selected either manually by a user familiar with the display parameters of each display device 120, or automatically based upon identifying electronic data stored within each display device 120, for example the extended display identification data (EDID) stored within each of the display devices 120. In some instances, the digital sign file 105 delivered to each of the one or more display devices 120A-C can therefore be optimized for the particular parameters (e.g., type, size, resolution, and orientation) of the display device 120.

The digital sign files 105A-G can be provided from any number of sources. Digital sign sources can include, but are not limited to, product manufacturers, product distributors, trade associations, governmental agencies (e.g., public service announcements and the like), advertising agencies, or third party providers. In at least some instances, multiple generations of digital sign files 105A-G may be available, for example a first-generation original digital sign file posted by a manufacturer, a second-generation digital sign file consisting of the original manufacturer file modified by a trade association, and a third-generation digital sign file consisting of the trade association file further modified by a third party to reflect local market conditions. Where such options exist, the field of signage available to a retailer is even more fruitful, allowing the retailer to choose signage tailored to his or her market conditions. In some instances, the retailer may gain access to signage heretofore unavailable or available only at high cost from a local third party customizer.

The repository 110 can include any one or more data storage location or locations suitable for the storage and retrieval of the plurality of digital sign files 105A-G. The repository 110 can be wholly or partially disposed remote from the computing device 115. In at least some embodiments, the repository 110 can be accessed via the internet with the computing device 115 using an internet protocol (e.g., TCP/IP) to establish a connection to the repository 110. In other embodiments, the repository 110 can include a proprietary storage location such as a server accessible for free or for a fee via a local area network (LAN), a wide area network (WAN), or a worldwide area network (WWAN, i.e., the internet).

In at least some embodiments, the repository 110 can be coupled 150A-C to the display devices 120A-C. Coupling 150A-C the repository 110 to at least a portion of the one or more display devices 120A-C can permit the wired or wireless delivery of digital sign files 105A-G from the repository 110 to the display devices 120A-C thereby minimizing or eliminating the need for intervening data processing or computing devices.

The repository 110 can be coupled to, and communicate with, the computing device 115 via a wired or wireless connection. The computing device 115 can be used to access and search the plurality of digital sign files 105A-G. In some embodiments, digital sign files 105A-G matching external selection criterion supplied via the computing device 115 can be communicated from the repository to the computing device 115 for subsequent distribution to one or more display devices 120A-C.

The computing device 115 can include any device or combination of devices suitable for accepting the external selection criterion 125 as an input, executing the logic 130, and communicating with the repository 110. The computing device 115 can access the repository 110 via LAN, WAN, or WWAN, either directly (e.g., via modem or network access card) or indirectly through another device or system (e.g., over a LAN or WAN connected to a server having network access). The computing device 115 can include, but is not limited to: portable computing devices such as netbook and laptop computers; desktop computing devices; and handheld computing devices and smartphones.

The computing device 115 can accept via a wired or wireless connection as an input the at least one external selection criterion 125 which can be any input to the computing device 115 capable of influencing, directing, or impacting the selection of one or more digital sign files 105A-G within the repository 110 based upon the inclusion of the external selection criterion 125 in the logic 130. The external selection criterion 125 can include an analog or digital data input to the computing device 115. Example digital data inputs can include, but are not limited to, local or remote inventory data, local or remote sales data, local environmental data, user entered data, or consumer entered data. Example analog data inputs can include, but are not limited to, audio data, video data, local or remote environmental data or the like. The external selection criterion can include social media inputs, for example YouTube® “hits,” Facebook® “likes,” or other similar indices of approval or disapproval entered by consumers on social networking sites.

For example, the external selection criterion 125 may include, for example, the ambient temperature or similar weather conditions around or about a retail establishment—such data could influence the selection of a swimsuit digital sign file 105F over a fur coat digital sign file 105G when the temperature is above 25° C. In another example, the external selection criterion 125 may include real time inventory data gathered from a retail establishment inventory database—such data could influence the selection of a milk digital sign file 105E over a banana digital sign file 105D when inventory data indicates a high inventory of milk, or when inventory data indicates the milk in stock is reaching its pull date for removal from sale. In yet another example, the external selection criterion 125 can include a user entered value, such as a store owner identifying his or her business as a bicycle shop—such data could influence the selection of a bicycle digital sign file 105C over sign digital sign files related to swimsuits 105F or fur coats 105G.

In some embodiments, at least a portion of the external selection criterion 125 can include subscription information limiting or otherwise curtailing access to all or a portion of the digital sign files 105A-G stored within the repository 110. The external selection criterion 125 can include information regarding a retailers terms of access to the digital sign files 105A-G—for example, the external selection criterion can include a limited number of digital sign files that a retailer can access or download based upon the terms of the subscription purchased by the retailer. In other embodiments, the digital sign files might be allocated into “standard” and “premium” classes and the retailer may subscribe to only one class to which access is permitted based, in whole or in part, upon the external search criterion 125.

The logic 130 can include any machine executable instruction set capable of providing access for the computing device 115 to the digital sign files 105A-G disposed within the repository 110. The external selection criterion 125 can be incorporated or reflected in the results generated by the logic 130 upon partial or complete execution on the computing device 115. In some embodiments, the logic 130 can be locally executed in whole or in part on the computing device 115. In other embodiments, although not depicted in FIG. 1, the logic 130 can be remotely executed in whole or in part on a remote computing device, for example a computing device remote from computing device 115.

Digital sign files 105A-G can be delivered directly or indirectly to the at least one display device 120A-C. In some embodiments, for example as depicted in FIG. 1, the digital sign files 105A-G can be delivered via a direct coupling 150A-C between the repository 110 to the display device 120A-C. In other embodiments, the digital sign files 105A-G can be indirectly delivered from the repository 110 to the display device 120A-C, for example, the digital sign files 105A-G can be delivered to an intermediate server, from which each of the plurality of display devices 120A-C can access the digital sign files 105A-G.

The one or more display devices 120A-C can include any device capable of delivering audio data, video data, image data, or any combination thereof including, but not limited to, a liquid crystal display (LCD), a light emitting diode (LED) display, a cathode ray tube (CRT) display, or any other visual display technology currently in use or to be developed. The one or more display devices 120A-C can be of equal similar format or performance capability, however such similarity is not necessary as, in some embodiments, the format or performance capability of each of the digital sign files 105A-G displayed on the one or more display devices 120 can be optimized to the format or specific display parameters of each display device 120.

In at least some embodiments, some or all of the one or more display devices 120A-C can include an audio output, to permit the simultaneous broadcast of both visual and audible output. The one or more display devices 120A-C can have any size, shape, or form factor. For example, the one or more display devices 120A-C can include both a 42 inch LCD digital sign located on the sales floor and a 7 inch LED retail point of sale display.

Example Digital Signage Transaction Method

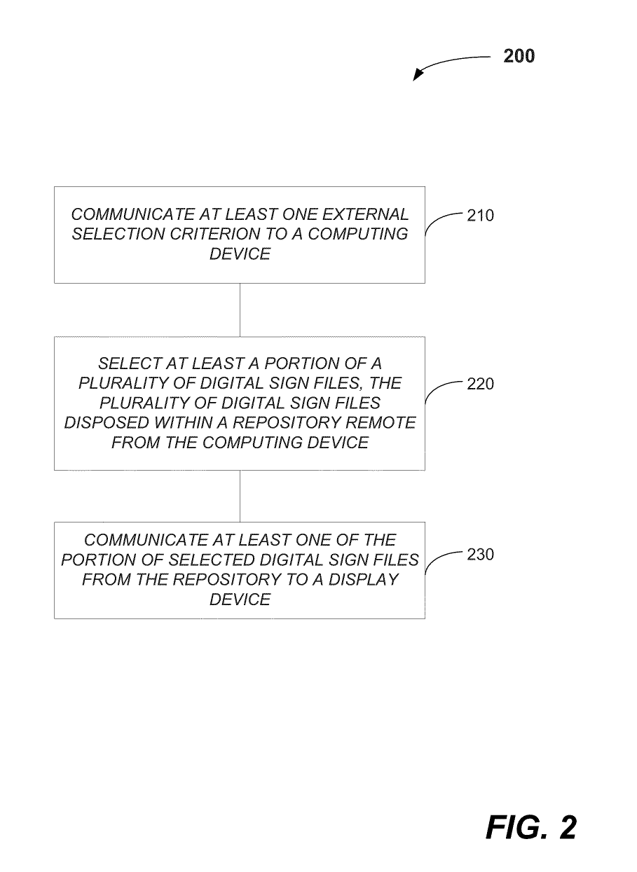

FIG. 2 is a flow diagram depicting an illustrative digital signage transaction method 200, according to one or more embodiments. The method 200 can permit the intelligent selection of digital sign files 105A-G from the repository 110 and the transmission of the selected digital sign files 105A-G to some or all of the display devices 120A-C. The method 200 can include communicating at least one external selection criterion 125 to a computing device 115 at 210. The computing device 115 can be coupled to a repository 110 having a plurality of digital sign files 105A-G disposed therein. The external selection criterion 125 can include any one or more criteria useful in selecting at least a portion of the digital sign files 105A-G from the repository 110.

The communication of the external selection criterion 125 to the computing device 115 can be accomplished manually, for example by a user entering the external selection criterion 125 into the computing device 115, or automatically, for example by the receipt of a digital data stream or file containing the external selection criteria 125 by the computing device 115.

The method 200 can further include selecting at least a portion of the plurality of digital sign files 105A-G within the repository 110 responsive to the receipt of the external selection criterion 125 at 220. The selection of the digital sign files 105A-G may be based, in whole or in part, upon the external selection criteria 125. In some embodiments more than one external selection criterion 125 can be used for example, one manually entered external selection criterion and one automatically entered external selection criterion. The selection of the digital sign files 105A-G can be achieved, for example, by keyword matching between the external selection criteria 125 and the metadata associated with each of the digital sign files 105A-G. Similar concept matching or keyword based selection processes can also be used to select appropriate digital sign files 105A-G based upon the external selection criteria 125 provided to the computing device 115.

The method 200 can also include communicating at least a portion of the selected digital sign files 105A-G from the repository 110 to the one or more display devices 120A-C at 230. The selected digital sign files 105A-G can be transmitted from the repository 110 directly to the one or more display devices 120A-C via one or more intervening networks such as a LAN, WAN, or WWAN. In at least some instances, each of the display devices 120A-C can be individually addressable by the repository 110, for example using Internet Protocol (IP4 or IP6) addressing. In some embodiments, the selected digital sign files 105A-G can be transmitted from the repository 110 indirectly to the one or more display devices 120A-C, for example by transmission to an intervening file server coupled to the one or more display devices 120A-C by a LAN. When received at the display device 120, the digital sign file 105 can be broadcast using the video and audio capability of the display device 120.

Another Example Digital Signage Transaction Method

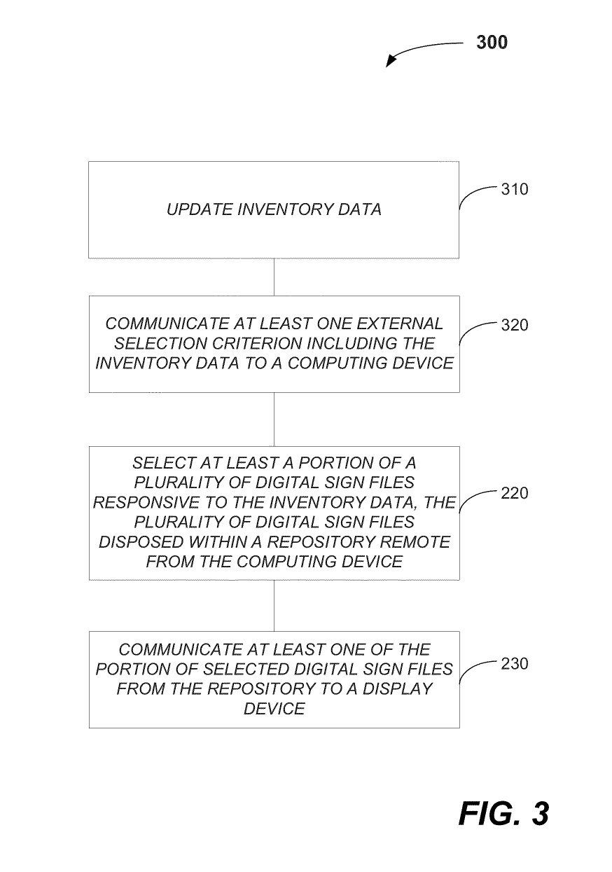

FIG. 3 is a schematic depicting another illustrative digital signage transaction method 300, according to one or more embodiments. The digital signage method 300 depicted in FIG. 3 provides a sample digital signage transaction method employing inventory data as the external selection criteria 125 to select appropriate digital sign files 105 from the repository 110 for display on one or more display devices 120. Such an implementation may be found in a retail establishment, where the retailer is seeking to advertise overstock inventory or inventory that is nearing its pull date. Such signage can provide an avenue for the retailer to minimize or eliminate losses due to overstock or otherwise unsalable merchandise.

The method 300 can include updating inventory data at 310. In some instances the inventory data can be collected in real time or in near real time, for example using an electronic retail point of sale system. The inventory data can be generated and stored at least partially within an inventory management system located within the retail establishment, or located on a remote server coupled to the retail establishment. All or a portion of the inventory data CaO be used to provide at least a portion of the external selection criterion 125. For example, when the inventory data indicates an item having a stock level in excess of a predetermined maximum, the item data can be used to provide the external selection criterion 125 such that digital sign files encouraging consumers to purchase the item are communicated to the display devices 120.

The method 300 can also include communicating the at least one external selection criterion 125 including the inventory data to a computing device 115 at 320. In one instance, the external selection criterion 125 can be generated by an inventory control system. The inventory control system can transmit the external selection criterion 125 to the computing device 115, for example via a network connection linking the inventory control system to the computing device 115.

Example Digital Signage Transaction System

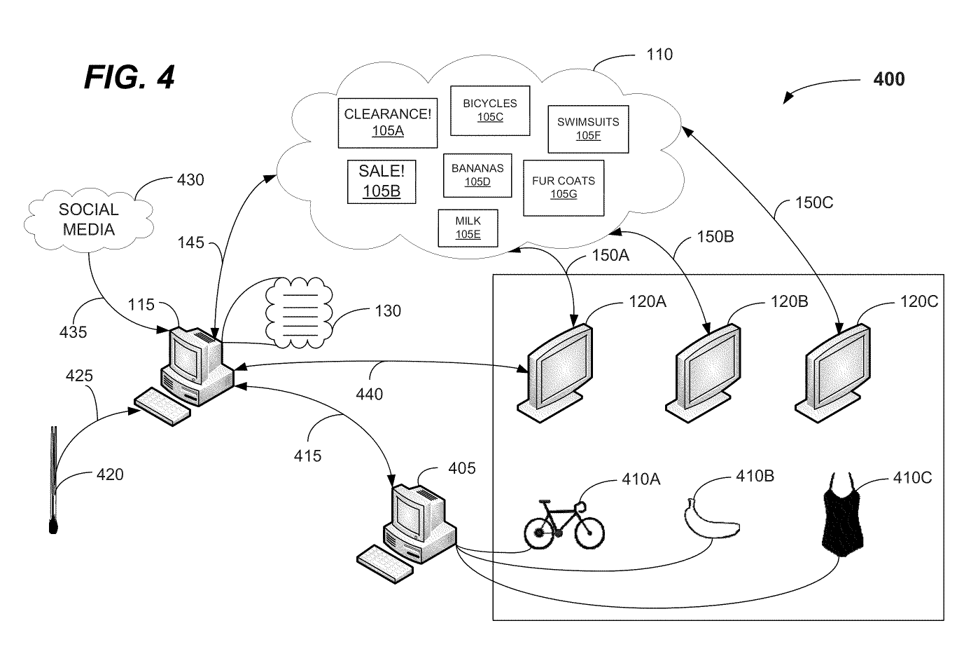

FIG. 4 is a schematic diagram depicting another illustrative digital signage transaction system 400, according to one or more embodiments. The system 400 illustrates a sample digital signage transaction system having multiple external selection criteria 125, including: inventory data 410A-C, ambient condition (e.g,, temperature) data 420, and social media data 430. In at least some embodiments, any one or more of the external selection criteria 125 depicted in FIG. 4 can be used to select appropriate digital signage files 105A-G from the repository 110.

Inventory data 410A-C can be transmitted from a retail point of sale terminal to an inventory management or control system 405. Such systems can track the thousands of items appearing on a retail sales floor, for example bicycles 410A, bananas, 410B, and swimsuits 410C. As inventory is received and sold, the inventory management or control system 405 can maintain an accurate count of the number of items on the retail sales floor. The inventory data can be transmitted 415 from the inventory management or control system 405 to the computing device 115, thereby providing all or a portion of the external selection criterion 125. As an example, consider inventory data supplied to the computing device 115; as the logic 130 considers the inventory data, digital sign files 105 may be selected from the repository 110 corresponding to inventory items exceeding a predetermined inventory threshold (i.e., “overstock” items) or corresponding to inventory items exceeding a predetermined temporal threshold (i.e., “old” or “near expiration” items).

The inventory management or control system 405 can also assist in directing the digital sign files 105 to an appropriate location on the retail sales floor. For example, one would not ordinarily expect to see a digital display showing “fur coats” 105G proximate a floor display of swimsuits 410C; likewise, one would not expect to see a digital display showing “bicycles” 105C proximate a floor display of bananas 410B. The use of an inventory management and control system 405 can assist in minimizing the likelihood of inappropriate digital display content being displayed on the retail floor.

Ambient condition data 420 can be transmitted 425 to the computing device 115 to provide at least a portion of the external selection criterion 125. Ambient weather conditions can be used to select appropriate digital sign files 105 from the repository 110; for example, where the ambient weather conditions provide an external selection criterion indicating a sunny day, digital sign files 105 containing an advertisement for sun block might be selected as more appropriate versus digital sign files containing an advertisement for bumbershoots. Similarly, where the ambient weather conditions provide an external selection criterion indicating a temperature in excess of 35° C., digital sign files 105 containing an advertisement for swimsuits might be selected as more appropriate versus digital sign files containing an advertisement for fur coats.

Social media data 430 can be transmitted 435 to the computing device 115 to provide at least a portion of the external selection criterion 125. Social media data can include any electronic data or input capable of providing an indication of public opinion, for example YouTube® “hits” or Facebook® “likes.” For example, a product advertisement shown during a major sporting event draws a significant number of “hits” on YouTube®—this provides an indication of public approval or acceptance of the advertisement. This indication can be used to provide at least a portion of the external selection criterion 125 transmitted to the computing device 115.

Display device parameters, for example EDID data, can be transmitted 440 from the one or more display devices 120A-C to the computing device 115 to provide at least a portion of the external selection criterion 125. For example, display devices 120A-C disposed about a retail floor may be of differing sizes or resolutions. The size and resolution data can be transmitted 440 to the computing device, thereby providing, in whole or in part, the external selection criterion 125. Such data would permit the delivery of digital sign files 105A-G optimized for viewing on each display device—for example high definition (HD) digital sign files might be transmitted to HD compatible display devices 120, while standard definition digital sign files might be transmitted to non-HD compatible display devices 120.

While the foregoing is directed to embodiments of the present invention, other and further embodiments of the invention may be devised without departing from the basic scope thereof, and the scope thereof is determined by the claims that follow.

We claim the following:

1. A digital signage transaction system, comprising:
a plurality of digital sign data files disposed within a repository accessible by a computing device;
at least one display device coupled to the repository;
at least one external selection criterion coupled to the computing device; and
logic responsive to the at least one external input, which when executed by the computing device:
selects at least one of the plurality of digital sign data files from the repository; and
communicates the at least one selected digital sign data file to the at least one display device.

2. The system of claim 1, the at least one external selection criterion comprising a criterion to select digital signage from the repository associated with the criterion.

3. The system of claim 1, the at least one external selection criterion comprising an environmental criterion to select digital signage from the repository associated with the environmental criterion.

4. The system of claim 1, the at least one external selection criterion comprising a social media rating criterion to select from the repository digital signage having a favorable social media rating criterion.

5. The system of claim 1, the at least one external selection criterion comprising an inventory criterion to select from the repository digital signage associated with one or more inventory items having a count greater than a predetermined inventory threshold.

6. The system of claim 1, further comprising an inventory management system coupled to the computing device, the at least one external selection criterion comprising the inventory management system to select from the repository digital signage associated with one or more items having an inventory residence duration greater than a predetermined threshold in the inventory management system.

7. The system of claim 1, the at least one external selection criterion comprising a subscription for the supply of digital sign data files to select digital signage from the repository in accordance with the subscription terms.

8. The system of claim 1, the at least one external selection criterion comprising at least one display parameter associated with the at least one display device.

9. The system of claim 1, the repository comprising a world-wide web accessible storage device contemporaneously accessible to multiple users.

10. The system of claim 1, the computing device and the at least one digital display device disposed within a retail sales environment.

11. The system of claim 7, the subscription comprising at least one of: a temporal-based subscription and a cost-based subscription.

12. A digital signage transaction method, comprising:
communicating at least one external selection criterion to a computing device;
responsive to the at least one external selection criterion, selecting at least a portion of a plurality of digital sign data files, the plurality of digital sign files disposed within a repository remote from the computing device; and
communicating at least one of the portion of selected digital sign files from the repository to a display device.

13. The method of claim 12, further comprising:
tracking inventory using an inventory management system; and
transmitting inventory data to the computing device to provide the at least one external selection criterion.

14. The method of claim 12, further comprising:
assimilating social media information relevant to a product;
transmitting the assimilated social media information to the computing device to provide the at least one external selection criterion.

15. A digital signage transaction method, comprising:
updating inventory data;
communicating at least one external selection criterion including the inventory data to a computing device;
responsive to the inventory data, selecting at least a portion of a plurality of digital advertising media files disposed in a repository remote from the computing device; and
communicating at least one of the portion of selected digital advertising media files from the repository to a display device.

16. The method of claim 15, wherein selecting at least a portion of the digital sign data files comprises:
selecting digital sign files corresponding to items having an inventory duration exceeding a predetermined threshold.

17. The method of claim 15, wherein selecting at least a portion of the digital sign data files comprises:
selecting digital sign files corresponding to items having an inventory count in excess of a predetermined threshold.

18. The method of claim 15, wherein selecting at least a portion of the digital sign data files comprises:
selecting digital sign files corresponding to items having an inventory characteristic matching a predetermined value.

19. The method of claim 15, wherein selecting at least a portion of the digital sign data files comprises:
selecting digital sign files corresponding to items having a physical location matching a predetermined value.
